(19) United States
(12) Patent Application Publication
(10) Pub. No.: US 2010/0147960 A1
(43) Pub. Date: Jun. 17, 2010

(54) METHODS, DEVICES, AND SYSTEMS FOR PRINTING BAR CODES

(75) Inventor: Martin Bailey, Cambridge (GB)

Correspondence Address: DARBY & DARBY P.C., P.O. BOX 770, Church Street Station, New York, NY, 10008-0770, US

(73) Assignee: Global Graphics Software Limited, Cambridge (GB)

(21) Appl. No.: 12/337,146

(22) Filed: Dec. 17, 2008

(51) Int. Cl. G06K 19/06

(52) U.S. Cl. 235/494

(57) ABSTRACT

A method of preparing a document containing a bar code for printing includes providing a trigger font in a representation of the document to indicate a bar code; and providing characters in the representation of the document and after associated with the trigger font, where the characters provide a bar code representation. When displayed, the bar code representation does not have a same appearance as the bar code but is a placeholder for the bar code in the document.

### FIELD

The present invention is directed to the area of printers, printed documents, and printer software and hardware, as well as to methods of printing. In addition, the present invention is directed to methods of printing bar codes and documents containing the bar codes.

### BACKGROUND

Conventionally, there are three main methods in use for creating a print stream that requests a printer to draw a bar code on a page: 1) use a bar code font, where each glyph in the font represents a component of the final bar code; 2) use a pre-created graphic representation of the bar-code, e.g. in a raster format such as TIFF, or as vector objects in a format such as EPS (Encapsulated PostScript); or 3) include instructions in the print stream to request that specific bar code printing support in the printer (or elsewhere in the workflow) constructs the bar code according to those instructions. As an example of this latter method, a bar code is sent as a sequence of proprietary PCL (Printer Command Language) commands that are specific to bar code creation and not included in the official PCL specifications available from Hewlett Packard.

The use of a bar code font suffers from several disadvantages. A number of factors affect the final appearance of printed pages, such as the width of printed rules, ink spread, write-white vs. write-black electrophotographic processes, and the like. These can lead to different results on different printers, or on different media (e.g. papers) on the same printer. Varying stroke weights can adversely affect the readability of bar codes. As a result compensation may be applied to graphics to improve the consistency of printing on different devices or different media, for instance by requesting a narrower rule than is actually desired when printing on a device/media combination that will cause the rule to appear wider than was requested. When printing on different printers and media that require different compensation for edge growth (either positive or negative), then different fonts are typically used. This situation makes it difficult to prepare a single document, or a single data set and printing form within a database, for use across many different printers. If compensation is not applied, or is applied incorrectly for the printer/media in use then the reliability of reading the resulting bar codes may be greatly reduced.

Another disadvantage is that all check-sums within the bar code must be pre-computed so that the correct characters are included in the print stream. This may be difficult when designing forms within an environment that does not have specific support code for the bar code symbology to be used, such as many database report generators.

Yet another disadvantage is that high-density one-dimensional bar codes often do not have a one-to-one relationship between a collection of marks to be made on the page and a character in the data stream that the code represents. Thus any automated creation of a bar code includes a computational step in which the data stream is transformed into the correct sequence of characters in the bar code font. In many environments there is no API (Application Programming Interface) available to enable such a transformation step.

Another disadvantage is that correct printing of two-dimensional bar codes may sometimes require more precise control over line-spacing than is available in a database report generator.

The use of a pre-created graphic representation of a bar code suffers from several disadvantages. For example, when printing on different media that require different compensation for edge growth (either positive or negative) as a result of ink spread or write-white vs. write-black electrophotographic processes or the like, then different graphic representations are typically used, making it difficult to prepare a single document, or a single data set and printing form within a database, for use across many different printer/media combinations. If compensation is not applied, or is applied incorrectly for the printer/media in use then the reliability of reading the resulting bar codes may be greatly reduced.

As another example, in many creation environments, such as database report generators, it is time-consuming to add individual graphic elements other than those directly created by that environment. Thus the placement of pre-created files for bar codes is often only available or practical if the same bar code is to be used for all records. If the bar code is to be dynamically generated based on data held within each record then the cost of file import and placement is often prohibitive. In many database report generators it is not possible to automatically construct bar code graphics based on the contents of a data record, or a sequence number and then place them within a form design.

The use of specific bar code printing support also has some limitations. For example, in many creation environments, such as database report generators, the facilities for inclusion of instructions for a printer or print workflow are limited or missing. It may be possible to define the placement, font and size in which database record fields should be printed, but the conversion from that level of information to an encoding in a page description language or printer control language is defined within the database binary code and is not generally accessible to the database administrator. A small number of database report generators include support for specific bar code printing solutions, such as the support for BarDIMM in SAP/R3, Oracle and BAAN, but such specific integrations serve only to highlight the lack of free choice of database, print solution and bar code symbology combinations available. For example, the use of BarDIMM restricts printing to the use of the PCL printing language, and to a subset of printers that support the PCL extensions for BarDIMM.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of system for printing a document containing a bar code, according to the invention;

FIG. 2 is a schematic flow chart of one embodiment of a method of generating a bar code representation, according to the invention;

FIG. 3 is a schematic flow chart of one embodiment of a method of generating a bar code from a bar code representation, according to the invention;

FIG. 4 is a schematic flow chart of another embodiment of a method of generating a bar code from a bar code representation, according to the invention;

FIG. 5 is a schematic flow chart of yet another embodiment of a method of generating a bar code from a bar code representation, according to the invention.

### DETAILED DESCRIPTION

The present invention is directed to the area of printers, printed documents, and printer software and hardware, as well as to methods of printing. In addition, the present invention is directed to methods of printing bar codes and documents containing the bar codes.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The methods described herein can be performed using any type of computing device, such as a computer or printer, that includes a processor or any combination of computing devices where each device performs at least part of the process.

Suitable computing and printer devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

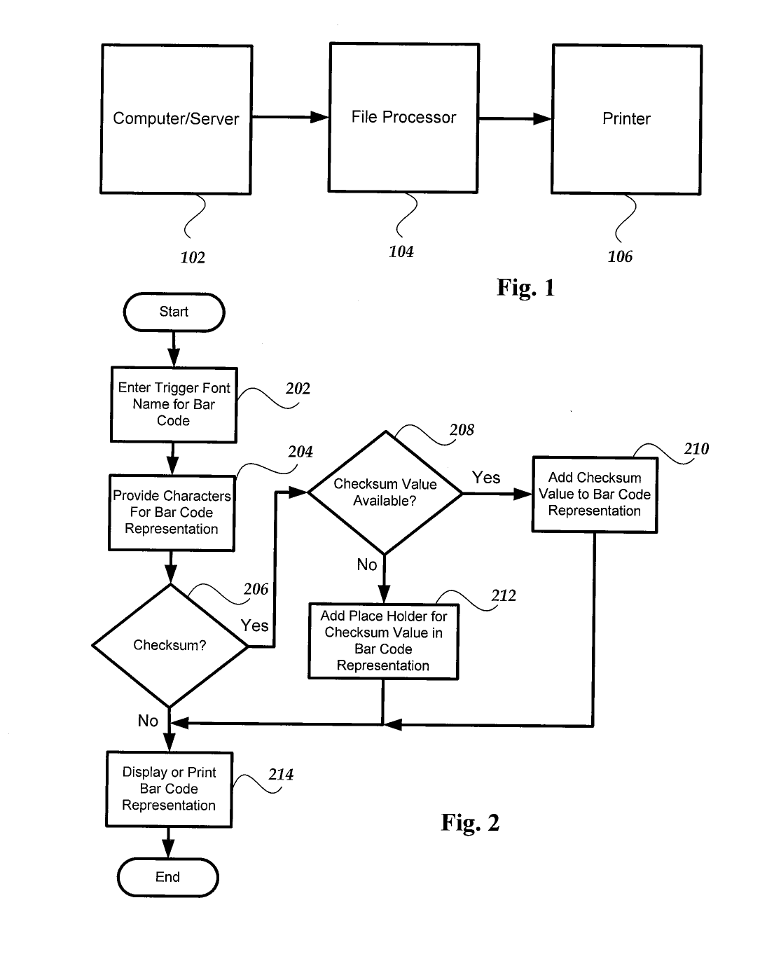

FIG. 1 illustrates one embodiment of a system for printing bar codes and documents containing bar codes. A computer or server 102 generates or stores a file to be used in printing a bar code or a document containing a bar code. For example, the file to be printed can be created on a computer, which may be a workstation with a human operator; or created or retrieved from a server, such as the report generator on a database. The computer or server 102 typically includes a printer driver. The document can be a final document, a draft document, or a form that can be filled in (or is filled in). The document can include text, graphics, and the like, or any combination thereof.

A file containing the document can be provided, for example, using the printer driver, to a file processor 104 (such as a Raster Image Processor (RIP) or a Digital Front End (DFE)) to convert the file into a format useable by the printer 106 to print the document. The file processor 104 can be, at least in part, included with the printer 106 or the computer/server 102 or both. For example, the file processor is a server computer which may optionally have hardware assistance included within it. As another example, the file processor is sometimes within the casing of the printer or in a separate box that is dedicated to that printer. In some embodiments, the interpreting and rendering components of the file processor may be both in a device that is outside of the printer casing, both within the casing of the printer, or separated such that, for example, the interpreter is in a device outside the printer casing and the renderer is on a computer board or second computer that is mounted within the printer casing. The computer 102, file processor 104, printer 106, or any combination thereof can include an interpreter, such as a page description language (PDL) interpreter to convert a bar code representation into a graphical representation (or a raster representation) of the bar code.

The present invention combines at least some of the advantages of the conventional methods of printing bar codes, while avoiding at least some of the disadvantages. As a result it can be effective at allowing accurate bar code printing on a wide variety of media, while simultaneously enabling the administrators of even database report generators with very limited PDL command-level access to use that facility. The sequence of data that is to be printed in a bar code will be described as the “data stream” below.

An individual, for example, a database administrator (or equivalent in other forms of print stream creation environments), can make a request that a bar code be printable by selecting a specific font that has been designed for the purpose, and will be referred to as a “trigger font”. In at least some embodiments, a different trigger font can be selected for each bar code symbology (e.g. UPC-A, EAN, POSTNET etc) or sub-classes of symbologies.

The trigger font is constructed using appropriate metrics (character widths, heights, side-bearings, and the like) so that the data stream will occupy the appropriate space in any visual preview of the page to be printed when represented simply with glyphs from the trigger font (i.e. with no transformations or character encodings or the like). The use of equivalent metrics also provides that text and other graphical elements that are positioned relative to the bar code can be placed or displayed correctly. This may include, for example, the size and position of a rectangular rule around the bar code, or of a white rectangle placed behind the bar code to distinguish it from any background image. It may also include the vertical position of any text placed below the bar code on the page, as well as many other aspects of the page layout.

The trigger font may be supplied in any font format that is appropriate for the operating system and database form design tool (or other page layout or design tool) in use. Thus TrueType, OpenType or PostScript Type 1, amongst others, may be used in at least some systems.

In at least some embodiments, when printing a bar code symbology that includes the computation of a check-sum or equivalent, the data stream may include a representation of the bar code data that includes a check-sum that has already been computed. In that case the value of the check-sum can be included in the sequence of bytes that make up the data stream. When a check-sum has not been pre-computed, the sequence of bytes chosen can include a character that represents the position of the check-sum, without also conveying the value that the check-sum will take (see the PostScript example below). In the database form design it will often be possible to add the character to represent the check-sum as a separate element on the form, rather than including it in the original data record, or the check-sum can be added programmatically as part of form generation. This is especially useful when the check-sum digit occurs as the first or last byte in the data stream, as it does in symbologies such as UPC.

In at least some embodiments, implementations of bar code symbologies (particularly simply symbologies), such as “code 3 of 9” the visual representation of the trigger font may match or approximate the actual visual appearance of the desired printed bar code. This is advantageous as it allows an administrator to rapidly review a form design, but such visual representation of the actual bar code is not required for correct operation. For example, it may not be possible to achieve a close approximation when using high-density bar code symbologies. The bar code representation can then simply be a placeholder for the actual bar code that will be printed. In at least some embodiments, the visual appearance of the trigger font characters should be such that it is immediately recognisable that it is not intended to match the correct appearance of the bar code.

FIG. 2 illustrates one embodiment of a method of producing a bar code representation. A trigger font name is entered for the bar code (step 202) and then characters are provided for the bar code representation and associated with the trigger font (step 204). If a checksum is to be added (step 206) and the checksum value is available (step 208) then the checksum value is added to bar code representation (step 210). If a checksum is to be added, but the checksum value is not available, then a placeholder for the checksum value is added to the bar code representation (step 212). After the bar code representation is generated (with or without the checksum value or placeholder), the bar code representation can be displayed or printed (step 214).

When one or more pages are converted into a print stream, e.g. as a result of requesting a database to print one or more records, the request for the text in the trigger font is serialised into the appropriate format in the page description language (PDL) being used. Common PDLs include Adobe PostScript, or Hewlett Packard's Printer Command Language (PCL), but other PDLs may be used.

The data stream is passed through unchanged as a series of bytes that will be interpreted as character codes by the printer. This removes any need for the availability of an API in the PDL creation process in the database report generator, as no transformation is required.

Thus a calling sequence for a UPC bar code, transmitted in PostScript, might appear as follows:

100 120 moveto
/BC_UPC 40 selectfont
(03600029145X) show

In this example the trigger font is named “BC_UPC”, and is to be printed at 40 points, 100 points from the left margin of the page and 120 points from the bottom. The product code is 03600029145. In the embodiment for which this example was created, the character ‘X’ is used to represent the position for a check-digit that has not yet been calculated.

The trigger font, in TrueType, PostScript, or other similar formats, may be embedded within the print stream if that is a feature enabled by the selected PDL, or may be completely omitted. Its presence is not required, and, if present, it may be ignored in some embodiments, as described below.

At some stage in the print workflow the PDL is interpreted and any sequences of characters in the trigger font are identified. Identification of the trigger font varies by the PDL used for the print stream. In at least one embodiment the trigger font in a PostScript stream is identified by its name. When other PDLs are used the font may be identified by a unique identifier, by an index to a pre-defined table of fonts, or by any other suitable identification method.

The specific trigger font; the position, size, and orientation of the character sequence; as well as the characters used within the sequence, are provided as configuration input for specialist bar code drawing software equivalent to that currently invoked in bar code printing in response to specific instructions for such a software process in the page description language.

Thus the presence of a sequence of characters in the print stream that the PDL identifies as to be printed using the trigger font is used rather than a specific command sequence for printing the bar code. This method is therefore usable with all print stream creation applications that enable the font size and position to be selected for individual data fields. In addition, the data stream is included in the print stream unchanged, removing the requirement for an API within the print stream creation software for transforming the data, and avoiding a need to pre-generate a graphical representation of the bar code.

Information describing print characteristics of the specific printing technology and media in use, including the print resolution and the edge-growth compensation requirements, is also supplied to the bar code drawing software, for example, directly from the printer in use, through a user interface, or from a database of such configurations.

Thus the bar code font is not used directly for printing, but simulates the appearance (at least the relative size and shape) of the bar code based on the character sequence, size, orientation, and compensation factors. Edge growth can therefore be factored into the appearance in a way that often cannot be achieved by printing the bar code directly.

The interpretation and bar code trigger identification may be performed in at least two different locations within the print workflow. For example, it may be performed within the PDL interpreter used to render to a raster representation each page in a form suitable for a marking engine of the printer. Such interpreters may run, for example, on a controller board embedded within the casing of the printer itself, or may run on a digital front end (DFE) comprising a separate computer connected to the printer or may run in a computer that generates or stores the document to be printed. In such a case the bar code can be drawn as a set of graphical primitives that are processed in the same way as every other graphical element on the page, e.g. by inclusion in a display list that is built as a result of interpreting the PDL. (Not all RIPs build display lists, although the majority do.)

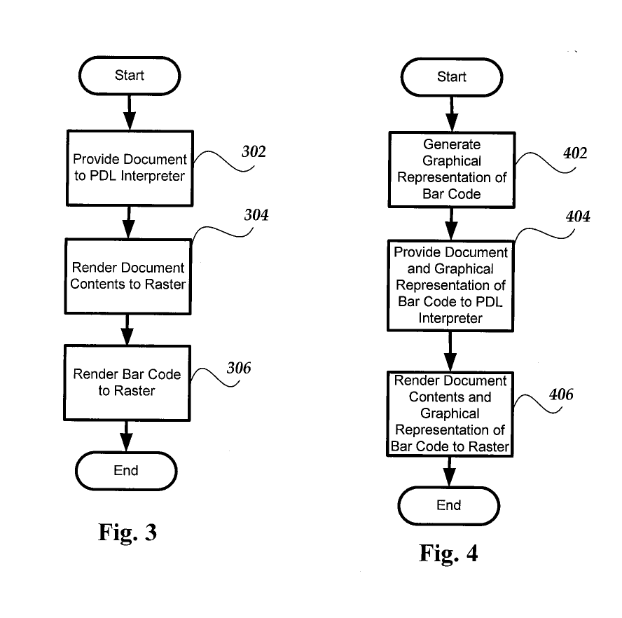

FIG. 3 illustrates one embodiment of a method of interpreting the bar code representation. The document is provided to an interpreter, e.g., a PDL interpreter (step 302). The interpreter renders the document contents to raster (step 304). The interpreter also renders the bar code representation to raster (step 306).

As another example, the interpretation and bar code trigger identification can be performed as a step in the print workflow, but before the interpreter used for page rendering within the printer or associated DFE. In this case the bar code is drawn as a sequence of graphical elements that represent the marks to be drawn for the actual, printed bar code, encoded in the same PDL as the rest of the print stream. Thus, a bar code within a PCL data stream would be re-encoded into PCL drawing commands and passed on to the DFE or printer within the rest of the PCL print stream. The representation used for the bar code may be vector based (e.g. collections of instructions to draw rectangles or other shapes), or may be a raster (e.g. an image encoding the final appearance of the bar code). When a raster is used it is preferably at the correct resolution for the printer.

FIG. 4 illustrates one embodiment of another method of interpreting the bar code representation. The interpreter or another device generates a graphical representation of the actual bar code using the bar code representation (step 402). The document and the graphical representation are provided to an interpreter, e.g., a PDL interpreter (step 404). The interpreter renders the document contents and the graphical representation of the bar code to raster (step 406).

In at least some embodiments, the interpreter is configured to recognize a request for text to be printed in one or more trigger fonts (representing one or more bar code symbologies or sub-classes of symbologies). When a request to print text is received by the interpreter, it would normally either add a text graphical primitive to the display list (if the interpreter is running within a printer or DFE), or pass that request through to the output print stream (if the interpreter is running within a separate workflow component). Instead, when the request is received to print text using a trigger font the interpreter does not immediately perform those operations, but records the size, position and rotation of the requested text.

The interpreter then determines if the requested text in the trigger font completes the data to draw a bar code. Each bar code symbology may use a specific amount of data, which may vary depending on the value of data that occurs early in its sequence. For some bar code symbologies it is possible to determine that a whole bar code sequence has been received based only on a count of the characters in the stream. Other symbologies include an explicit end character (such as the ‘*’ character at the end of a “code 3 of 9” bar code) to signify the end of the bar code. In those cases where sub-classes of a symbology may be used, and where the number of characters appropriate for representing the data required in the print stream is different for each sub-class, a different trigger font may be used for each sub-class to avoid any ambiguity as to the identification of the end of a bar code sequence. Alternatively, an additional character that does not form a part of the bar code data stream itself may be defined to explicitly mark the end of the bar code data; this may be particularly useful for bar code symbologies, such as QR, that allow varying amounts of data to be encoded. These approaches can ensure that it is definitively possible to identify that all data for a bar code has been received.

If all of the data for a bar code has been received then a check-sum is calculated if required or desired, and the bar code is drawn as a graphical entity. If the data for the bar code is incomplete, the interpreter will return to processing the incoming print stream as a request to draw a single sequence of characters may be split into multiple PDL commands. Thus the example PostScript sequence above could also have been encoded as:

100 120 moveto
/BC_UPC 40 selectfont
(036000)show
(29145) show
(X) show

Or even as the following, where the characters of the sequence are not in the correct order in the print stream, but in three blocks, each of which is individually positioned. In the extreme case each character may be placed individually:

/BC_UPC 40 selectfont
230 120 moveto
(X) show
180 120 moveto
(29145) show
100 120 moveto
(036000)show

If the next command that would draw a graphical element in the incoming print stream is another request for text in the same trigger font then the position, size and rotation of that request is compared with that of the previous such request. If the positioning is such that it has the same base-line as, and is adjacent to the previous request, then the composite character sequence from the new request and any currently stored requests is constructed, taking into account the possibility that newly added characters may not fall at the end of the sequence, and stored. If the sequence is now a complete bar code, then the bar code is processed.

In at least some embodiments, if a partial bar code has been recorded, but, for example, a) a graphical element other than another text request in the same trigger font at the same text size is encountered, or b) a request for text in the trigger font is encountered that does not align with previous requests and is therefore regarded as a separate request, or c) the end of the current page is encountered, then there may be an error in the print stream. If an error is determined, the interpreter may halt the job with appropriate error messages or continue to print ignoring the conflicting commands. Additional criteria may be used to identify error conditions in some PDLs, such as a ‘restore’ operator in PostScript.

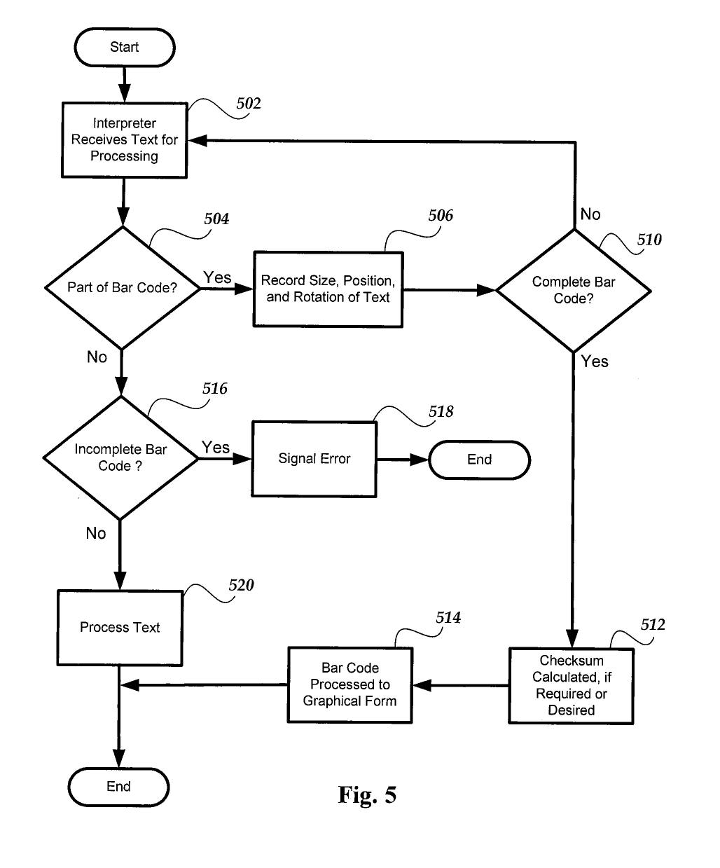

FIG. 5 is a flowchart of one embodiment of a method of converting the bar code representation to an actual bar code for printing. The interpreter (or other device) receives text from the file to be printed (step 502). If the text is part of a bar code representation (step 504) then the size, position, and rotation of the text is recorded (step 506). If a complete bar code has been received (step 510), a checksum is calculated if required or desired (step 512) and the bar code is processed to provide a graphical form of the actual bar code (step 514), for example, a rasterized version of the bar code or graphical form that can be rasterized. If the bar code is not complete (step 510), then further text is received (step 502) and the process continues until the full bar code is received.

If the received text is not part of a bar code representation (step 504), but an incomplete bar code has been received (step 516) then an error is signalled (step 518) and the process is halted. Alternatively, the error may be noted and the processing of the file is continued, but the incomplete bar code is notated as an error or is left completely off a final raster. If the received text is not part of a bar code representation (step 504) and there is no incomplete bar code (step 516) then the text is processed (step 520), e.g., a rasterized version of the text is formed. It will be recognized that the file may also include graphical information that would also be processed (e.g., rasterized).

In at least some embodiments, if the check-sum has been pre-calculated and included in the print stream the bar code drawing software may be configured to determine that it has been correctly calculated and to trigger appropriate error handling if it has not. If the check-sum was represented using a character that identifies its position without representing its value, then the check-sum is calculated at this time, and the position character replaced by one that also conveys the value. Additional validation of the bar code, for example, determining whether the bar code meets minimum or maximum size limits or has a particular format or is in a particular numerical, alphabetical, or alphanumerical range or ranges (or any combination thereof) may also be performed.

In drawing the final bar code representation, the position and size of the sequence of characters in the bar code trigger font is taken into account. For a one-dimensional bar code such as EAN or UPC the bar code can be placed with its lower left corner at the origin of the first character of the character sequence (after taking account of any character rotation) if desired. The bar code can be scaled such that its height matches the cap-height of the trigger font, and its right edge is aligned with the right extent of the last trigger font character position, if desired.

Some one-dimensional bar code systems include white “quiet zones” to the left, to the right or at both ends of the graphic representation of the code to allow a bar code reader to more easily recognise the bar code as such. Quiet zones may be explicitly included in the trigger font character sequence in the print stream. If present they will be taken into account when drawing the bar code; if not present, the bar code drawing software can be configured to automatically add quiet zones according to the bar code symbology's requirements, for example, by drawing a white rectangle that extends across the quiet zones and the bar code area before or after drawing the bar code itself.

Some bar code symbologies are two dimensional (e.g. Datamatrix 2D or Aztec). The same method as described above may be used to include a 2D bar code into the print stream. In at least some embodiments, the characters within the trigger font are designed to be tall and narrow, so that a single line of characters in that font fills the appropriate space for the whole of the 2D bar code.

If a print stream is delivered to a print workflow or printer that does not include the bar code representation systems and methods described herein, but does support the PDL used for the stream, then one of three outcomes may occur. For many combinations of database report generator and print stream PDL format the database administrator may have the opportunity to configure the database in order to select which of these outcomes occurs:

a) The page does not print but an error message reporting that a required font could not be found is issued. This may be desirable, in that no imperfect prints can accidentally enter a delivery process where they would could problems because the bar codes would be uncompensated and may not be reliably readable.

b) The page prints but uses a default font for the bar code trigger font. In a PostScript printer the most common default font would be Courier. This may be desirable in allowing the rest of the print form to be proofed on any available printer, while ensuring that the imperfect bar code is easily identifiable as such.

c) The page prints using a copy of the trigger font embedded within the print stream. For some simple symbologies where the trigger font can emulate the bar code well this may be a useful fall-back for emergency situations where the print system embodying the current invention is not available. The edge-gain compensation provided by the current invention will not typically be applied, and the reliability of bar code reading may be adversely affected. For higher density bar code symbologies the printed representation will not be readable as a bar code. As a result, for such symbologies it is better that the trigger font be designed with a visual representation that is immediately detectable as not being a bar code.

It will be understood that each block of the flowchart illustrations in FIGS. 2-5, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The computer program instructions, or portions of the computer program instructions, can be stored on any suitable computer-readable medium including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of preparing a document containing a bar code, the method comprising:
providing a trigger font in a representation of the document to indicate a bar code; and
providing characters in the representation of the document and after associated with the trigger font, wherein the characters provide a bar code representation that, when displayed, does not have a same appearance as the bar code but is a placeholder for the bar code in the document.

2. The method of claim 1, further comprising displaying the bar code representation with the document, wherein the bar code representation does not have a same appearance as the bar code but is a placeholder for the bar code in the document.

3. The method of claim 2, wherein the displayed result of the bar code representation occupies a same amount of space as the bar code when the document is displayed.

4. The method of claim 1, wherein the representation of the document is a page description language (PDL) representation of the document.

5. The method of claim 4, further comprising providing the bar code representation to a PDL interpreter to render the bar code into raster.

6. The method of claim 4, further comprising generating a graphical representation of the bar code using the bar code representation.

7. The method of claim 6, further comprising providing the graphical representation of the bar code to a PDL interpreter to render the bar code into raster.

8. The method of claim 1, further comprising providing at least one portion of the representation of the document to an interpreter;
identifying the trigger font using the interpreter;
identifying, using the interpreter, at least one portion of the representation of the document that is the bar code representation; and
generating, using the interpreter, a graphical representation of the bar code using the bar code representation.

9. The method of claim 8, further comprising calculating a checksum for the bar code.

10. The method of claim 8, further comprising signaling an error if only an incomplete bar code representation is providing in the at least one portion of the representation of the document.

11. The method of claim 1, wherein the document is a form.

12. The method of claim 1, further comprising including a checksum value in the bar code representation.

13. The method of claim 1, further comprising including a placeholder for a checksum value in the bar code representation, wherein the placeholder is not the checksum value.

14. A system for preparing a document containing a bar code, comprising:
at least one processor;
a display coupled to the at least one processor, and
a computer readable storage medium having processor-executable instructions, the processor-executable instructions when installed onto the system enables the at least one processor to perform actions, comprising:
providing a trigger font in a representation of the document to indicate a bar code; and
providing characters in the representation of the document and after associated with the trigger font, wherein the characters provide a bar code representation that, when displayed, does not have a same appearance as the bar code but is a placeholder for the bar code in the document.

15. The system of claim 14, further comprising a computer coupled to the at least one processor and configured and arranged to store the representation of the document.

16. The system of claim 14, further comprising a printer coupled to the computer and the at least one processor.

17. The system of claim 16, wherein the at least one processor comprises a page description language (PDL) interpreter.

18. The system of claim 16, wherein the PDL interpreter is disposed on a device other than the computer and the printer.

19. A computer readable storage medium having processor-executable instructions, the processor-executable instructions when installed onto a system enable the system to perform actions, comprising:
providing a trigger font in a representation of a document to indicate a bar code; and
providing characters in the representation of the document and after associated with the trigger font, wherein the characters provide a bar code representation that, when displayed, does not have a same appearance as the bar code but is a placeholder for the bar code in the document.

20. The computer readable storage medium of claim 19, wherein the processor-executable instructions when installed onto a system further enable the system to perform actions including:
displaying the bar code representation with the document, wherein the bar code representation does not have a same appearance as the bar code but is a placeholder for the bar code in the document.

21. The computer readable storage medium of claim 19, wherein the processor-executable instructions when installed onto a system further enable the system to perform actions including:
providing at least one portion of the representation of the document to an interpreter;
identifying the trigger font using the interpreter;
identifying, using the interpreter, at least one portion of the representation of the document that is the bar code representation; and
generating, using the interpreter, a graphical representation of the bar code using the bar code representation.

22. The computer readable storage medium of claim 19, wherein the document is a form.
